(19) United States
(12) Patent Application Publication
(10) Pub. No.: US 2026/0276530 A1
(43) Pub. Date: Sep. 17, 2026

(54) SENSOR

(71) Applicant: Endress+Hauser Conducta GmbH+Co. KG, Gerlingen (DE)

(72) Inventor: Ralf Bernhard, Stuttgart (DE)

(21) Appl. No.: 19/568,040

(22) Filed: Mar. 16, 2026

(30) Foreign Application Priority Data
Mar. 17, 2025 (DE) 10 2025 110 142.6

(51) Int. Cl. G01N 21/31

(52) U.S. Cl. CPC G01N 21/31; G01N 2201/0636

(57) ABSTRACT

A sensor for measuring at least one measured variable of a medium, comprising: a transmission system, configured to transmit electromagnetic transmission radiation along a transmission path into the medium; a lens arranged on an input side in the transmission path; a measuring detector, configured to receive measurement radiation resulting from an interaction of the transmission radiation with the medium and to determine and provide at least one property of the measurement radiation dependent on the at least one measured variable; and at least one reference detector arranged such that a part of a radiation fraction of the transmission radiation reflected on the lens impinges thereon, and configured to determine and provide at least one reference property of the thereon impinging part of the radiation fraction of the transmission radiation reflected on the lens.

### CROSS-REFERENCE TO RELATED APPLICATIONS

The present application is related to and claims the priority benefit of foreign patent application No. DE 10 2025 110 142.6, filed Mar. 17, 2025, the entire contents of which are incorporated herein by reference.

### TECHNICAL FIELD

The present disclosure relates to a sensor for measuring at least one measured variable of a medium, comprising a transmission system, which is formed to transmit electromagnetic transmission radiation along a transmission path into the medium, a lens installed input side in the transmission path and a measuring detector, which is formed to receive measurement radiation resulting from an interaction of the transmission radiation with the medium and to determine and provide at least one property of the measurement radiation dependent on the measured variable.

### BACKGROUND

Sensors, for instance optical sensors, comprising a transmission system and a measuring detector, and receiving measurement radiation resulting from an interaction of transmission radiation with the medium are already applied in a number of different applications in the state of the art. Various measured variables can be measured with these sensors, depending on the type of interaction. Examples known from the state of the art include turbidity sensors for measuring turbidity of the medium, sensors for measuring concentration of solids contained in the medium, fluorescence sensors, and absorption sensors, such as e.g. absorption sensors for measuring at least one measured variable, such as e.g. spectral absorption arising in the medium in the case of one or more transmission wavelengths, absorption arising in the medium in the case of one or more transmission wavelength ranges, or an absorption spectrum of the medium, and/or sensors for measuring at least one measured variable determinable based on the above mentioned measured variables, such as e.g. a concentration of an analyte contained in the medium.

For measuring turbidity, as well as also for measuring a solids concentration contained in the medium, generally, light is transmitted into the medium and a measured variable dependent intensity of the measurement radiation scattered or reflected on particles contained in the medium is measured.

In the case of fluorescence sensors, procedure includes e.g. that a fluorescing component contained in the medium is excited by light radiated into the medium and a measured variable, such as e.g. a concentration of the fluorescing component, is determined based on the intensity or the spectral intensity values of the fluorescent radiation resulting from the excitation.

For absorption measurements, generally, transmission radiation is transmitted through the medium and at least one of the above mentioned measured variables determined based on the intensity or the spectral intensity values of the measurement radiation emerging from the medium.

Independently of the type of applied interaction, there is in the case of these sensors the problem that generally at least one property of the transmission radiation, for example, the intensity of the transmission radiation or at least one spectral intensity value of the transmission radiation, enters decisively into the measuring. These properties can change, however, with time and/or as a function of environmental conditions, such as e.g. the temperature. In given cases, the spectral composition of the transmission radiation can change. Correspondingly, there is the danger that changes of properties of the transmission radiation relevant for the measuring lead to degradation of the quality of the measurement, for example, the accuracy of measurement.

This problem can be confronted e.g. by equipping the sensors with a reference detector for measuring and/or monitoring at least one property of the transmission radiation. Reference measurements executed with these reference detectors offer the advantage that aging transmission systems can be replaced timely and/or an influence of the property(ies) of the transmission radiation, in given cases, changing as a function of time, can be compensated.

For this, the reference detector can be arranged e.g. in such a manner that a fraction of the transmission radiation transmitted by the transmission system along a reference path different from the transmission path impinges thereon. This solution is implementable simply and cost effectively without additional optical elements. It assumes, however, that changes of the properties of the transmission radiation act in the same manner in the two radiation directions determined by the orientations of the transmission path and the reference path.

This proviso is, however, not directly fulfillable, for example, in the case of transmission systems with emission spectra dependent on spatial direction, such as e.g. in the case of light emitting diodes. Light emitting diodes, generally, comprise a semiconductor chip arranged on a support, such as e.g. a reflector trough. These semiconductor chips have regularly a highly direction dependent radiation characteristic because of their mounting and design. This radiation characteristic leads to a directed radiation of the transmission radiation in a transmission direction predetermined by the orientation of the light emitting diode. The directional dependence of emission spectra of light emitting diodes is frequently amplified supplementally by arranging the semiconductor chip under a dome shaped covering, which protects the semiconductor chip and assumes the function of a lens. The directed radiation from light emitting diodes with or without covering, advantageous as regards measuring of the measured variable(s), leads, however, unavoidably to the fact that transmission radiation transmitted by the transmission system along the transmission path extending in parallel with the transmission direction and transmission radiation transmitted by the transmission system along a reference path differ from one another by a greater amount, the greater the angle is between the transmission path and the reference path. Small angles require a positioning of the reference detector in the immediate vicinity of the transmission path. But then it can happen, depending on embodiment of the sensor, that, in given cases, there is not sufficient space for accommodating the reference detector. Moreover, the closeness of the reference detector to the transmission path can lead to degradation of the transmission radiation transmitted along the transmission path. With reference to the accommodating of the reference detector, large angles, such as e.g. angles in the order of magnitude of 90°, would be advantageous. However, at such large angles to the transmission direction, light emitting diodes emit, because of the above described construction, practically no radiation.

This problem can be confronted by placing in the transmission path a beam divider, by which a first part of the incoming transmission radiation passes through in the direction of the medium, and a second part is reflected in the direction of an appropriately positioned reference detector. Disadvantageous in such case, however, is that the beam divider represents an extra component, which increases the production costs. Moreover, space is required in a region of the sensor surrounding the transmission path at the height of the beam divider for accommodating the reference detector. Furthermore, the electrical connecting of the correspondingly positioned reference detector can, in given cases, be associated with additional effort.

Described in DE 10 2022 104 685 A1 are sensors for measuring a measured variable of a medium. The sensors comprise a transmission system, which is formed to transmit electromagnetic transmission radiation along a transmission path into the medium, and a measuring detector, which is formed to receive measurement radiation resulting from an interaction of the transmission radiation with the medium and to determine and provide at least one property of the measurement radiation dependent on the measured variable. These sensors include a lens installed input side in the transmission path and, installed terminally in the transmission path, a prism, through which transmission radiation is transmitted into the medium and measurement radiation resulting from the interaction of the transmission radiation with the medium is received. Additionally provided is a reference detector, which receives a fraction of the transmission radiation reflected at the prism and provides a reference detector signal, from which at least one reference property of the fraction of the transmission radiation reflected on the prism can be obtained.

That offers the advantage that changes of the transmission radiation arising, in given cases, anywhere along the total transmission path extending from the transmission system to the prism are registered also by means of the reference detector and can be correspondingly taken into consideration. Disadvantageous, however, is that space in a region surrounding the prism sensor is required for accommodating the reference detector and the electrical connection of the correspondingly positioned reference detector is, in given cases, associated with additional effort. Moreover, this form of reference measurement is usable only in the case of sensors with correspondingly positioned prism.

### SUMMARY

It is an object of the present disclosure to provide a sensor of the above mentioned type, with which at least one property of the transmission radiation interacting with the medium can be determined and/or monitored in cost effective, space saving manner.

For this, the present disclosure resides in a sensor for measuring at least one measured variable of a medium, comprising
a transmission system, which is formed to transmit electromagnetic transmission radiation along a transmission path into the medium,
a lens installed input side in the transmission path,
a measuring detector, which is formed to receive measurement radiation resulting from an interaction of the transmission radiation with the medium and to determine and provide at least one property of the measurement radiation dependent on the measured variable, and
at least one reference detector, which is arranged in such a manner that a part of a radiation fraction of the transmission radiation reflected on the lens impinges thereon, and which is formed to determine and provide at least one reference property of the thereon impinging part of the radiation fraction of the transmission radiation reflected on the lens.

The sensor of the present disclosure offers the advantage that, apart from the lens (required, generally, in any event, for collimating the transmission radiation) and the reference detector, no additional components are required for determining the reference property(ies). Another advantage is that the properties of the radiation fraction reflected on the lens agrees especially with the properties of the transmission radiation transmitted along the transmission path to the medium, when the transmission system has an emission spectrum dependent on spatial direction. Moreover, the sensor offers the advantage that the one or more reference detectors are positionable space savingly in the vicinity of the transmission system, without the transmission radiation transmitted into the medium being degraded thereby. That offers the advantage that, thereby, also the effort associated with the electrical connection of the reference detector is simultaneously reduced.

Embodiments include that
the sensor is formed as a turbidity sensor, as a sensor for measuring a solids concentration contained in the medium, as a fluorescence sensor, as an absorption sensor, as a sensor working according to the principle of fluorescence quenching, as an oxygen sensor working according to the principle of fluorescence quenching or as a sensor working according to the principle of attenuated total reflection,
the transmission system includes at least one light source, at least one light emitting diode, an incandescent light bulb, a flash lamp, a gas discharge lamp, a xenon lamp, at least one laser diode or a laser,
for this, the transmission system is formed to transmit transmission radiation in a spectral region having at least one transmission wavelength and/or at least one transmission wavelength range,
the transmission system includes either a light source, which transmits light in the spectral region of the transmission system, or two or more light sources operable at the same time and/or in a time sequence determined by means of a control unit and transmitting light in different subranges of the spectral region of the transmission system,
   the measuring detector includes at least one detection system, at least one photodiode, a detector array, a photodiodes array or a spectrometer, and/or is formed to determine, as at least one property of the measurement radiation dependent on the measured variable, an intensity, at least one spectral intensity value or an intensity spectrum of the measurement radiation,
each reference detector comprises at least one detection system, at least one photodiode, a detector array, a photodiodes array or a spectrometer, and/or is formed to determine, as at least one reference property, an intensity, at least one spectral intensity value and/or an intensity spectrum of the part of the radiation fraction of the transmission radiation reflected on the lens and impinging on the reference detector, and/or
the reference detector, at least one of the reference detectors or each reference detector each includes a detection system or a detection system embodied as a photodiode and a filter placed in front of the detection system, wherein the filter is formed as a bandpass filter, as an edge filter, or as a notch filter and/or as a filter transparent in a wavelength range predetermined for the reference detector.

In a first further development, the sensor comprises a support or a support comprising a circuit board, wherein the transmission system and each reference detector are arranged on a side of the support facing the lens.

Further developments of the first further development include that the measuring detector is arranged on the support and/or the sensor includes an optical system, which is formed to transmit measurement radiation resulting from the interaction with the medium to the measuring detector arranged on the support.

A second further development includes that
the lens is embodied in such a manner that the radiation fraction reflected on the lens propagates as a divergent beam formed rotationally symmetrically to a symmetry axis predetermined by an orientation of an optical axis of the lens extending coaxially with the transmission path, and
two or more reference detectors are arranged in a plane extending spaced from the lens and perpendicularly to the symmetry axis and are distributed in such a manner around the symmetry axis that they are located at equal separations from the symmetry axis.

Other further developments include that the sensor comprises two or more reference detectors, wherein the reference detectors are arranged in a plane, the reference detectors are arranged distributed around the transmission system, and/or the transmission system and the reference detectors are arranged on a side of a support facing the lens in such a manner that the reference detectors are arranged distributed around the transmission system in a circular ring shaped region of the support.

A third further development provides that the reference detectors comprise, for two or more subranges of a spectral region of the transmission system, for the case of each subrange, a reference detector, which is formed to determine, as reference property, an intensity of the thereon impinging part of the reflected radiation fraction in the subrange of its case.

In at least one embodiment of the third further development, the sensor includes a measuring electronics connected to the measuring detector and to each reference detector, wherein
the measurement radiation results from a wavelength-preserving interaction, and
the measuring electronics is formed to determine and provide measured values of the measured variable of the medium based on ratios of intensities or spectral intensity values of the measurement radiation determined as properties in the individual subranges of the measuring detector to the intensity determined in each subrange as reference property by the reference detector provided for each subrange.

A fourth further development provides that the sensor comprises a control device connected to the transmission system and formed to control a transmission intensity of the transmission radiation transmitted by the transmission system to a predetermined, desired intensity based on at least one reference property determined by one or more reference detectors connected to the control device.

A fifth further development provides that the sensor comprises a monitoring system connected to the reference detector or to at least one or each reference detector and formed to monitor the transmission radiation transmitted by the transmission system based on at least one or each reference property determined by one or more reference detectors connected to the monitoring system and/or to output an alarm, when a reference property and/or a characteristic variable determined by the monitoring system based on the reference property(ies) lies outside of a desired range predetermined therefor.

At least one further development of the fifth further development provides that the monitoring system is formed to monitor a spectral composition of the transmission radiation transmitted by the transmission system based on reference properties determined with two or more reference detectors connected thereto in at least two different subranges of the spectral region of the transmission system and/or to output an alarm, when at least one characteristic variable of the spectral composition determined by the monitoring system based on the reference properties lies outside of a desired range predetermined therefor.

At least one other development of the fifth further development provides that
the reference detectors comprise, for at least two subranges of the spectral region of the transmission system, for the case of each subrange, a reference detector, which determines as reference property an intensity of the part of the thereon impinging part of the reflected radiation fraction in the subrange of its case, and
the monitoring system is formed to monitor the spectral composition of the transmission radiation based on one or more ratios of two reference properties determined in different subranges, and/or to output an alarm, when at least one of the ratios lies outside of a desired range predetermined therefor.

At least one embodiment provides that the sensor comprises a measuring electronics, which:
is connected to the measuring detector and to the reference detector or to at least one or each reference detector, and
is formed to determine and provide measurement results of the measured variable based on properties of the measurement radiation determined by the one or more measuring detectors and dependent on the measured variable and based on the reference properties determined by at least one reference detector.

A form of embodiment of the last embodiment provides that the measuring electronics is formed to determine the results of measurement as measurement result compensated with respect to a dependence of the properties of the measurement radiation dependent on the measured variable on at least one property of the transmission radiation metrologically registered based on the reference property(ies).

At least one form of embodiment of the last embodiment provides that
the reference detector is formed to determine as reference property an intensity of the thereon impinging part of the radiation fraction of the transmission radiation reflected on the lens, and
the measuring electronics is formed to determine and provide measured values of the measured variable of the medium based on ratios of intensities or spectral intensity values of the measurement radiation determined with the measuring detector as properties to the intensities determined as reference properties by the reference detector.

At least one form of embodiment of the last embodiment provides that
the measurement radiation results from a wavelength-preserving interaction,
the reference detector is formed to determine spectral intensity values of the thereon impinging part of the radiation fraction of the transmission radiation reflected on the lens as reference property,
the measuring detector is formed to determine as properties spectral intensity values of the measurement radiation, and
the measuring electronics is formed to determine and provide measured values of the measured variable based on ratios of the spectral intensity values determined by the measuring detector and the reference detector for the same wavelength.

### BRIEF DESCRIPTION OF THE DRAWINGS

The present disclosure and its advantages will now be explained in greater detail based on the figures of the drawing, in which a number of examples of embodiments are shown. Equal elements are provided in the figures with equal reference characters. The figures of the drawing show as follows:

FIG. 1 shows a sensor in the form of an absorption sensor;

FIG. 2 shows an additional sensor in the form of an absorption sensor;

FIG. 3 shows a sensor in the form of a turbidity sensor;

FIG. 4 shows a sensor in the form of a fluorescence sensor; and

FIG. 5 shows a support bearing a transmission system and a plurality of reference detectors.

### DETAILED DESCRIPTION

Each of FIGS. 1 to 4 shows an example of at least one embodiment of a sensor for measuring at least one measured variable of a medium 1. Each sensor comprises a transmission system 3, which is formed to transmit electromagnetic transmission radiation L0, such as e.g. light, along a transmission path P into the medium 1.

Transmission system 3 comprises, depending on type of measured variable(s), e.g. at least one light source, such as e.g. at least one light emitting diode, an incandescent light bulb, a flash lamp, a gas discharge lamp, a xenon lamp, at least one laser diode or a laser. Alternatively or supplementally, the transmission system 3 is e.g. formed to transmit transmission radiation L0 in a spectral region, which comprises transmission of a wavelength, a plurality of transmission wavelengths or at least one transmission wavelength range. For this, the transmission system 3 is e.g. formed in such a manner that it includes a light source, which transmits light in the spectral region of the transmission system 3. Alternatively, the transmission system 3 is e.g. formed in such a manner that it comprises two or more light sources operable at the same time and/or in a time sequence predetermined by means of a control unit, thus e.g. a plurality of light emitting diodes, which transmit light in different subranges of the spectral region of the transmission system 3.

Furthermore, each sensor comprises a measuring detector 5, which is formed to receive measurement radiation LM, such as e.g. absorption, reflection, scattering or fluorescence, resulting from an interaction of the transmission radiation L0 with the medium 1, and to determine and provide at least one property Iₘ of the measurement radiation LM, such as e.g. an intensity, at least one spectral intensity value and/or an intensity spectrum of the measurement radiation LM dependent on the measured variable. The measuring detector 5 includes, depending on type of property(ies) Iₘ dependent on the measured variable, e.g. at least one detection system, such as e.g. at least one photodiode or a spectrometer, or a detector array, such as e.g. an array of photodiodes. Alternatively or supplementally, the measuring detector 5 is e.g. formed to provide the property(ies) Iₘ of the measurement radiation LM in the form of a corresponding measuring detector signal d(Iₘ).

In at least one form of embodiment shown in FIG. 1, the sensor provides the measuring detector signal d(Iₘ) dependent on the measured variable directly as a measurement result of the measured variable. Alternatively or supplementally, the sensors can comprise a measuring electronics 7 depicted in FIGS. 1 to 4 as options connected to the measuring detector 5. Based on the property(ies) Iₘ determined by the measuring detector 5, the measuring electronics 7 determines measured values of the measured variable and provides such as a measurement result MR.

As shown in FIGS. 1 to 4, a lens 9 is placed input side in the transmission path P of each sensor. Lens 9 is e.g. oriented in such a manner that an optical axis of the lens 9 extends coaxially with the transmission path P. Alternatively or supplementally, lens 9 is formed e.g. as a collimation lens and/or formed by means of the transmission system 3 to collimate transmission radiation L0 fed into the transmission path P. Corresponding lenses are used in a number of sensors known in the state of the art for collimation of transmission radiation L0 transmitted in the direction of the medium 1 and represent, thus, a component available in the state of the art.

As shown in FIGS. 1 to 4, transmission radiation L0 is transmitted toward lens 9 by means of the transmission system 3 in a transmission direction extending in parallel with the transmission path P. That leads to the fact that a radiation fraction R of the transmission radiation L0 impinging on the lens 9 is reflected on the lens 9. In such case, the functionally related, at least sectionally curved form of the lens 9 leads to the fact that the reflected radiation fraction R propagates as a divergent beam in a direction extending oppositely to the transmission direction of the transmission system 3. In the case of forms of embodiment, in which the optical axis of the lens 9 extends coaxially with the transmission path P, the surface of the lens 9 facing the transmission system 3 and therewith also the reflected radiation fraction R are formed rotationally symmetrically to a symmetry axis extending coaxially with the optical axis of the lens 9.

The divergent reflection of the radiation fraction R on the lens 9 is usually not wanted, since such reduces the fraction of the transmission radiation L0 transmitted through the lens 9 in the direction of the medium 1. This, even in the application of high-grade optical lenses, unavoidable reflection is used in the sensors illustrated in FIGS. 1 to 4 to determine and/or to monitor at least one property of the transmission radiation L0.

For this, each sensor includes at least one reference detector 11, which is arranged, in each case, in such a manner that a part of the radiation fraction R of the transmission radiation L0 reflected on the lens 9 impinges thereon. For this, each reference detector 11 is, in each case, positioned in such a manner that a part of the divergent beam, propagating oppositely to the transmission direction and becoming always wider with increasing separation from the lens 9, impinges thereon. This positioning can occur in different ways. At least one form of embodiment provides that the transmission system 3 and each reference detector 11 of a sensor are each arranged in a shared plane. FIGS. 1 to 4 show, for this, examples of embodiments, in the case of which each of the illustrated sensors comprises, in each case, a support 13, such as e.g. a circuit board, on whose side facing the lens 9 the transmission system 3 and each reference detector 11 of a sensor are arranged. This form of embodiment offers the advantage that neither additional supports nor complicated connection wires are required for the reference detectors 11.

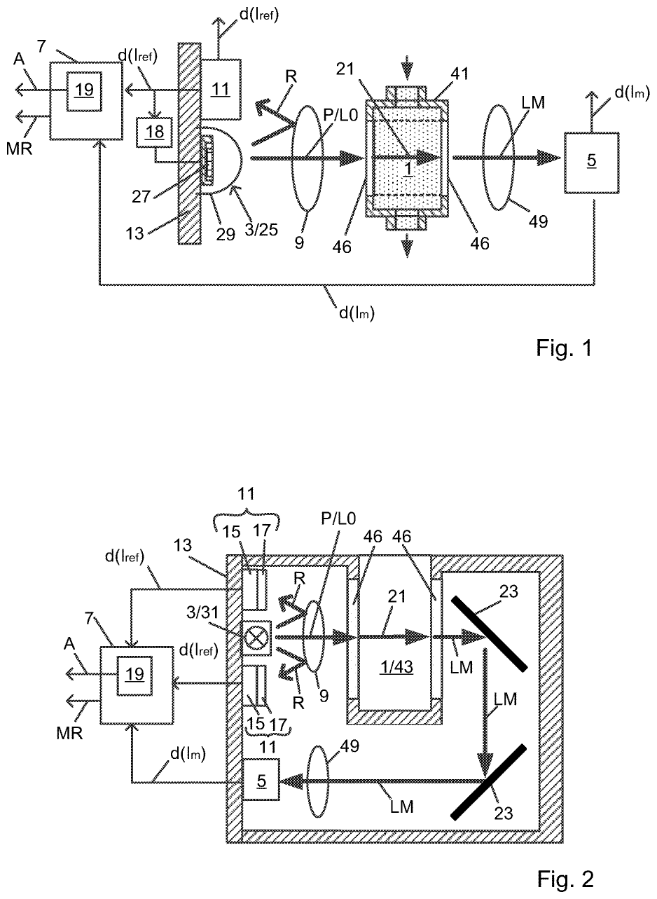

FIGS. 2 to 4 show examples of embodiments, in the case of which, supplementally, also the measuring detector 5 is arranged on the support 13. In the case of these examples of embodiments, the illustrated sensors comprise an optical system, which transmits measurement radiation LM resulting from interaction with the medium 1 to the measuring detector 5 arranged on the support 13. Alternatively, the measuring detector 5 can, however, also be arranged at some other position in such a manner that measurement radiation LM directly impinges thereon or is brought to the measuring detector 5 via an appropriately embodied optical system of the sensor.

Independently of the position of the measuring detector 5, each reference detector 11 of the sensors illustrated in FIGS. 1 to 4 is, in each case, formed to determine and provide at least one reference property I_{ref}, such as e.g. an intensity, at least one spectral intensity value or an intensity spectrum, of the thereon impinging part of the radiation fraction R of the transmission radiation L0 reflected on the lens 9.

That offers the advantage that properties of the transmission radiation L0 interacting with the medium 1 corresponding to the reference properties I_{ref} can be determined and/or monitored based on the reference properties I_{ref}. In such case, it is utilized that the radiation fraction R reflected on the lens 9 corresponds to the transmission radiation L0 as regards its spectral composition, and the reference properties I_{ref} determined with the reference detector 11 correspond to the properties of the transmission radiation L0 corresponding thereto.

Depending on type of reference property(ies) I_{ref} to be determined, each reference detector 11 comprises e.g., in each case, at least one detection system, at least one photodiode, a detector array, a photodiodes array or a spectrometer. Optionally, the reference detector 11 or at least one or each reference detector 11 can, in each case, comprise a detection system 15, such as e.g. a photodiode, and a filter 17 connected in front of the detection system 15. An example of an embodiment for this is shown in FIG. 2. In such case, each filter 17 is formed e.g. as a bandpass filter, an edge filter or a notch filter, and/or as a filter transparent in a wavelength range predetermined for the reference detector 11. Alternatively or supplementally, reference detectors 11 are e.g., in each case, formed to provide the reference property(ies) I_{ref} in the form of a corresponding reference detector signal d(I_{ref}).

Fundamentally, even a single reference detector 11 suffices to perform reference measurements of the properties of the transmission radiation L0. Examples of embodiments for this are shown in FIGS. 1 and 4. In such case, the single reference detector 11 can be formed in different ways, depending on type of transmission system 3. Thus, in connection with a transmission system 3, such as e.g. a single light emitting diode, which transmits transmission radiation L0 with a predetermined transmission wavelength, e.g. a reference detector 11, such as e.g. a photodiode, can be used, which determines as reference property I_{ref} in the case of the impinging transmission wavelength a spectral intensity of the part of the reflected radiation fraction R impinging thereon. Analogously in connection with a transmission system 3, which transmits transmission radiation L0 with transmission wavelengths in a predetermined spectral region, e.g. a reference detector 11, such as e.g. a photodiode, can be applied, which determines as reference property I_{ref} an intensity of the thereon impinging part of the reflected radiation fraction R in the predetermined spectral region. Alternatively, the reference detector 11 can, however, also comprise a spectrometer, which determines as reference property(ies) I_{ref} spectral intensity values and/or an intensity spectrum of the received part of the reflected radiation fraction R in the predetermined spectral region.

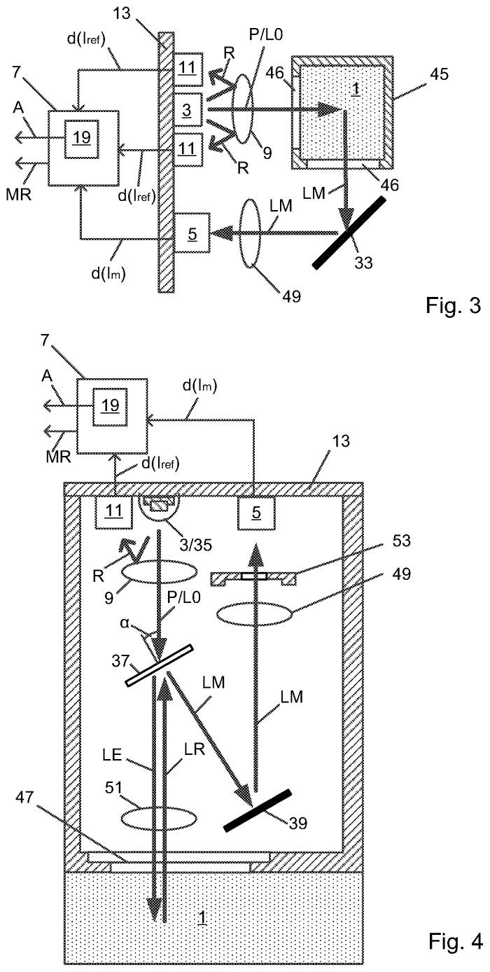

Instead of a single reference detector 11, the sensors described here can, however, also comprise two or more reference detectors 11. Examples of embodiments for this are shown in FIGS. 2 and 3. Also in the case of these examples of embodiments, the lens 9 is formed e.g. in such a manner that the radiation fraction R reflected on the lens 9 propagates as a divergent beam formed rotationally symmetrically to the symmetry axis predetermined by the orientation of the optical axis of the lens 9 extending coaxially with the transmission path P. This symmetry is utilized in the case of sensors comprising two or more reference detectors 11 e.g. such that the reference detectors 11 are located in a plane extending spaced from the lens 9 and perpendicularly to the symmetry axis in such a manner that they are arranged distributed around the symmetry axis with equal separation from the symmetry axis. This arrangement of the reference detectors 11 offers the advantage that the path, which the transmission radiation L0 travels from the transmission system 3 to the individual reference detectors 11, is equally long for all reference detectors 11. That offers the advantage that the reference properties I_{ref} determined by the individual reference detectors 11 are directly comparable, without requiring that influencing factors on the parts of the reflected radiation fraction R received by the individual reference detectors 11 related by variously long paths must be taken into consideration and/or compensated. Another advantage is that the parts of the reflected radiation fraction R received by the individual reference detectors 11 have the same spectral composition and the same spectral intensity values.

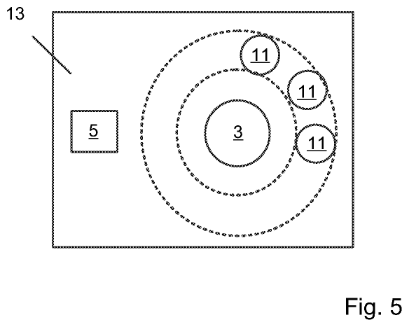

Alternatively or supplementally, the reference detectors 11 of sensors comprising two or more reference detectors 11 are e.g. arranged in a plane and distributed around the transmission system 3, and/or arranged on the same support 13. FIG. 5 shows, as an example of an embodiment for this, a view in a sensor of the side of the support 13 facing the lens 9, where the transmission system 3 is arranged, and where a number of reference detectors 11 are arranged distributed in a ring shaped region of the support 13 around the transmission system 3.

Independently of their arrangement in the sensor, two or more reference detectors 11 offer the advantage that then reference measurements of the properties of the transmission radiation L0 are performable in a number of different subregions of the spectral region in which the transmission system 3 transmits transmission radiation L0, corresponding to the number of reference detectors 11, and comprising, in each case, at least one transmission wavelength or transmission wavelength range, without requiring an expensive spectrometer. Thus, the sensor comprises for two or more subranges of the spectral region of the transmission system 3 e.g., in each case, a reference detector 11, which is formed to determine as reference property I_{ref} an intensity of the thereon impinging part of the reflected radiation fraction R in its subrange.

Suited for this as reference detectors 11 are photodiodes sensitive e.g. in different wavelength ranges, such as e.g. commercially available silicon carbide (SiC) photodiodes sensitive in different wavelength ranges. Suited as well are the above described reference detectors 11 having a detection system 15, such as e.g. a photodiode, and a filter 17 connected in front of the detection system 15 and transparent for the wavelength range predetermined for the reference detector 11. As shown in FIG. 2, in such case, e.g. also two or more reference detectors 11 with equally constructed or different detection systems 15 can be applied, before which is placed, in each case, a filter 17 transparent in a different subrange of the spectral region of the transmission system 3.

Thus, in connection with a transmission system 3 having a broadband light source, such as e.g. a xenon lamp, which transmits light in the ultraviolet, in the visible and in the near infrared regions, e.g. a reference detector 11 can be applied, which determines an intensity of the thereon impinging part of the reflected radiation fraction R in the ultraviolet subrange, a reference detector 11 can be applied, which determines an intensity of the thereon impinging part of the reflected radiation fraction R in the visual subrange, and/or a reference detector 11 can be applied, which determines an intensity of the thereon impinging part of the reflected radiation fraction R in the near infrared subrange.

Analogously in connection with a transmission system 3 comprising a plurality of light sources, such as e.g. a plurality of light emitting diodes, operable at the same time and/or in a time sequence predetermined by means of a control unit, and, in each case, transmitting light in a subrange of the spectral region of the transmission system 3, there can be provided, for at least one or each light source, in each case, a reference detector 11, which determines as reference property I_{ref} an intensity of the thereon impinging part of the reflected radiation fraction R in the subrange of the spectral region of the light transmitted by its light source.

Independently of the type and number of reference detectors 11, the reference properties I_{ref} determined by the reference detectors 11 can be utilized in different ways. A form of embodiment shown in FIG. 1 provides that the sensor is formed to output as measurement results the properties Iₘ of the measurement radiation LM determined by the measuring detector 5 and dependent on the measured variable and/or to provide the reference properties I_{ref} determined by the one or more reference detectors 11 as reference results. As shown in FIG. 1, the output occurs e.g. in that the results of measurement are made available as the measuring detector signal d(Iₘ) and/or the reference results are made available as the reference detector signals d(I_{ref}) of the one or more reference detectors 11.

At least one optional embodiment alternatively or supplementally usable for this, shown in FIG. 1 and usable analogously also in the other examples of embodiments, provides that a sensor of the present disclosure includes, connected to the transmission system 3, a control apparatus 18, which is formed to control the transmission intensity of the transmission radiation L0 transmitted by the transmission system 3 to a predetermined, desired intensity based on at least one reference property I_{ref} determined by one or more reference detectors 11 connected to the control apparatus 18.

Another, optional embodiment alternatively or supplementally usable for this and shown in FIGS. 1 to 4 provides that a sensor of the present disclosure includes a monitoring system 19, which is connected to the reference detector 11, or to at least one or each reference detector 11 of the sensor. Monitoring system 19 is e.g. formed to monitor the transmission radiation L0 transmitted by the transmission system 3 based on at least one or each reference property I_{ref} determined by one or more reference detectors 11 connected to the monitoring system 19, and/or to output an alarm A, when a reference property I_{ref} and/or a characteristic variable determined by the monitoring system 19 based on the reference property(ies) I_{ref} lies outside of a desired range predetermined therefor. Thus, e.g. an alarm A can be output, when the transmission intensity of the transmission radiation L0 monitored based on the reference property(ies) I_{ref} lies outside of a desired range predetermined therefor, and/or falls below a limit value predetermined therefor. In the case of forms of embodiment equipped with the above described control apparatus 18, this occurs only when changes of the transmission intensity, such as e.g. an aging related decrease of the transmission power, can no longer be sufficiently compensated by the control.

At least one embodiment, usable alternatively or supplementally for this, provides that the monitoring system 19 is formed to monitor a spectral composition of the transmission radiation L0 transmitted by the transmission system 3 based on reference properties I_{ref} determined with two or more reference detectors 11 connected thereto in at least two different subranges of the spectral region of the transmission system 3 and/or to output an alarm A, when at least one characteristic variable of the spectral composition determined by the monitoring system 19 based on the reference properties I_{ref} lies outside of a desired range predetermined therefor.

At least one form of embodiment for this provides that for at least two subranges of the spectral region of the transmission system 3, in each case, a reference detector 11 is provided, which determines as reference property I_{ref} an intensity of the thereon impinging part of the reflected radiation fraction R in its subrange of the spectral region, and the monitoring system 19 monitors the spectral composition in each case based on ratios of reference properties I_{ref} determined in two different subranges, and/or outputs an alarm A, when at least one of the ratios lies outside of a desired range predetermined therefor.

Monitoring of the spectral composition is especially advantageous when the transmission system 3 includes at least one light source, such as e.g. a xenon lamp, in the case of which the spectral composition of its emission spectrum can change due to aging phenomena and/or as a function of external influences, such as e.g. the temperature, or the transmission system 3 comprises a plurality of light sources transmitting light in different subranges of the spectral region of the transmission system 3 and whose transmission intensities can vary independently of one another.

In the examples of embodiments illustrated in FIGS. 1 to 4, monitoring system 19 is formed as a component of the measuring electronics 7. Alternatively, monitoring system 19 can, however, also be formed as a separate system connected to the reference detector 11 or to at least one or each reference detector 11.

At least one alternative or supplemental embodiment usable for this and shown in FIGS. 1 to 4 provides that the measuring electronics 7 connected to the measuring detector 5 is also connected to the reference detector 11 or to at least one or each reference detector 11. In such case, the measuring electronics 7 is e.g. formed to determine and provide measurement results MR of the measured variable based on properties Iₘ of the measurement radiation LM dependent on the measured variable and determined with the measuring detector 5, and based on reference properties I_{ref} determined by at least one of reference detectors 11 connected thereto.

In such case, the measuring electronics 7 is formed e.g. in such a manner that it determines and provides the results of measurement MR as measurement result MR compensated with respect to a dependence of the properties Iₘ of the measurement radiation LM dependent on the measured variable on at least one of the transmission radiation L0 metrologically registered property based on the reference property(ies) I_{ref}.

Both variants offer the advantage that all, in given cases, arising changes of the transmission radiation L0 depicted by the reference properties I_{ref} are automatically taken into consideration. Examples of changes include e.g. changes of the transmitted transmission radiation L0 brought about by aging phenomena of the transmission system 3 and/or environmental conditions, such as e.g. the temperature. This leads to correspondingly small measurement error of the results of measurement MR.

With the sensors described here, different forms of interaction of the transmission radiation L0 with the medium 1 can be utilized, depending on type of measured variable and/or the related embodiment of the sensor. Among such interactions are wavelength-preserving interactions, such as e.g. absorption, reflection or scattering, as well as wavelength-changing interactions, such as e.g. Raman scattering or fluorescence.

FIGS. 1 and 2 show examples of embodiments of sensors in the form of absorption sensors. These sensors are, depending on embodiment of the transmission system 3, the measuring detector 5 and/or the measuring electronics 7, e.g. formed to determine at least one measured variable, such as e.g. a spectral absorption occurring at one or more transmission wavelengths in the medium 1, an absorption occurring at one or more transmission wavelength ranges in the medium 1, an absorption spectrum of the medium 1, and/or at least one measured variable determinable based on the above mentioned, measured variables, such as e.g. concentration of an analyte contained in the medium.

The sensors illustrated in FIGS. 1 and 2 are formed in such a manner that the transmission system 3 in measurement operation transmits transmission radiation L0 through the medium 1 and the measuring detector 5 on a side of the medium 1 away from the transmission system 3 receives emerging measurement radiation LM. In such case, there occurs along an optical path 21 extending through the medium 1 a wavelength-preserving interaction of the transmission radiation L0 with the medium 1, where a fraction of the transmission radiation L0 entering the medium 1 is absorbed in the medium 1, depending on the wavelength-dependent absorption characteristics of the medium 1 and the length of the optical path 21.

In FIG. 1, the measuring detector 5 is arranged for this on the side of the medium 1 away from the transmission system 3. FIG. 2 shows an example of an embodiment, in the case of which the measuring detector 5 is on the same side of the medium 1 as the transmission system 3. In such case, the measuring detector 5 is arranged on the support 13, where also the transmission system 3 and the reference detectors 11 are arranged. For this, the optical system of the sensor shown in FIG. 2 is formed to bring the measurement radiation LM emerging on the side of the medium 1 away from the transmission system 3 to the measuring detector 5. FIG. 2 shows for this an example of an embodiment, in which the optical system includes reflectors 23, which reflect the measurement radiation LM back to the measuring detector 5.

In the case of absorption sensors, transmission system 3 comprises e.g. at least one light source, which transmits light in a spectral region, which includes at least one transmission wavelength and/or at least one transmission wavelength range between 180 nm to 12000 nm

FIG. 1 shows an example of an embodiment, in which the transmission system 3 comprises a light emitting diode 25, which transmits light in a spectral region, which comprises transmission of one wavelength or transmission of a wavelength range. Light emitting diode 25 is e.g. formed in such a manner that it comprises a semiconductor chip 27, which is arranged under a dome shaped covering 29, which protects the semiconductor chip 27 and assumes the function of a lens. Depending on embodiment, the semiconductor chip 27 comprises e.g. a semiconductor crystal, which is arranged on a metal support, such as e.g. a reflector trough.

Alternatively, the transmission system 3 can, however, also comprise two or more light sources. In such case, the transmission system 3 includes e.g. a plurality of light emitting diodes, each with a dome shaped covering, and/or at least one light emitting diode having two or more semiconductor crystals arranged under a single dome shaped covering, which protects them and assumes the function of a lens. Alternatively, the transmission system 3 can comprise one or more light emitting diodes without dome shaped covering.

FIG. 2 shows an example of an embodiment, in which the transmission system 3 comprises a broadband light source 31, which transmits light in a broad spectral range. Suited for this is e.g. a light source, e.g. a xenon lamp, which transmits light in a spectral region comprised of an infrared part, a visual part and/or an ultraviolet part.

FIG. 3 shows as a further example a sensor, in the case of which the wavelength-preserving interaction used to perform the measurements includes that a part of the transmission radiation L0 entering into the medium 1 is reflected and/or scattered in the medium 1, on particles and/or solids fractions contained in the medium 1. In such case, the measurement radiation LM is reflected and/or scattered radiation. In connection with such form of interaction, the sensor shown as an example in FIG. 3 is formed e.g. as a turbidity sensor or as a sensor for measuring a solids concentration contained in the medium 1. In both cases, the transmission system 3 includes e.g. at least one light source, such as e.g. a light emitting diode, an incandescent light bulb, a flash lamp, a gas discharge lamp or a laser, which transmits light in a spectral region comprising at least one transmission wavelength and/or at least one transmission wavelength range from 180 nm to 12000 nm.

Moreover, measuring detector 5 is positioned e.g. in such a manner and/or the optical system of the sensor is e.g. formed in such a manner that the measuring detector 5 receives scattered and/or reflected measurement radiation LM at an angle to the transmission direction of the transmission radiation L0 entering the medium 1 predetermined by the position of the measuring detector 5 and/or the form of the optical system. FIG. 3 shows for this an example of an embodiment, in the case of which the measuring detector 5 and the transmission system 3 are arranged on the same support 13, and the optical system includes a reflector 33, which reflects the thereon impinging, scattered and/or reflected measurement radiation LM to the measuring detector 5 at the angle to the transmission direction predetermined, in such case, by the position of the reflector 33. Alternatively, however, also other optical systems for transmission of the measurement radiation LM to the measuring detector 5 can be applied or the measuring detector 5 can be placed at the location of the reflector 33 shown in FIG. 3.

In the case of sensors using a wavelength-preserving interaction, such as e.g. the sensors illustrated in FIGS. 1 to 3 and having only a single reference detector 11, the reference detector 11 is e.g. formed to determine as reference property I_{ref} the intensity of the thereon impinging part of the radiation fraction R reflected on the lens 9 in the spectral region of the transmission system 3. In such case, the measuring electronics 7 is e.g. formed to determine and provide measured values of the measured variable(s) of the medium 1 based on the ratio of the intensities or spectral intensity values determined by the measuring detector 5 as properties Iₘ of the measurement radiation LM in the spectral region to the intensities determined by the reference detector 11 as reference properties Iₘ.

Alternatively, the single reference detector 11 is e.g. formed to determine as reference properties I_{ref} spectral intensity values of the thereon impinging part of the radiation fraction R in the spectral region of the transmission system 3 reflected on the lens 9. In such case, the measuring detector 5 is also formed to determine spectral intensity values of the measurement radiation LM in this spectral region. Correspondingly, the measuring electronics 7 is e.g. formed to determine and provide measured values of the measured variable(s) based on ratios of the spectral intensity values determined by the measuring detector 5 and the reference detector 11, in each case, at the same wavelength.

In the case of forms of embodiment, such as e.g. the sensors illustrated in FIGS. 2 and 3, in the case of which the sensor includes for two or more subranges of the spectral region of the transmission system 3, in each case, a reference detector 11, which determines as reference property I_{ref} an intensity of the thereon impinging part of the reflected radiation fraction R in its subrange of the spectral region, the measuring electronics 7 is e.g. formed to determine and provide measured values of the measured variable(s) of the medium based on ratios of the intensities or spectral intensity values of the measurement radiation LM determined in the individual subranges by the measuring detector 5 as properties Iₘ to the intensity determined by each reference detector 11 provided in its subrange as reference property I_{ref}.

The is not limited to sensors using wavelength-preserving interactions, such as e.g. the sensors illustrated in FIGS. 1 to 3, but, instead, can be used analogously also in connection with sensors using a wavelength-changing interaction, such as e.g. fluorescence or Raman scattering. FIG. 4 shows as an example a sensor formed e.g. as a fluorescence sensor. In the case of fluorescence sensors, the interaction is provided e.g. in that a fluorescing component contained in the medium 1 is excited by the transmission radiation L0 to fluoresce. In such case, the measurement radiation LM given off by the component is fluorescent radiation. In the case of this form of embodiment, the measuring electronics 7 is e.g. formed to determine and to output the measured variable formed, in such case, e.g. by a concentration of the component contained in the medium 1 based on the intensity, the spectral intensity or the intensity spectrum of the measurement radiation LM.

In the case of sensors formed as fluorescence sensors, transmission system 3 comprises e.g. at least one light source, which transmits light into the medium 1 in a spectral region coordinated with the fluorescing component of the medium 1. Depending on component, suited for this is a light source, such as e.g. a light emitting diode, an incandescent light bulb, a flash lamp, a gas discharge lamp or a laser, which transmits transmission radiation L0 having at least one transmission wavelength in the range from 180 nm to 1200 nm. The transmission system 3 shown in FIG. 4 only as an example includes a light emitting diode 35, which is constructed e.g. analogously to the light emitting diode 27 shown in FIG. 1, and is formed to transmit light having at least one transmission wavelength coordinated with the fluorescing component, such as e.g. a transmission wavelength of 255 nm.

In connection with sensors, such as e.g. the sensor shown in FIG. 4, which utilize a wavelength-changing interaction, such as e.g. fluorescence, the measuring detector 5 is e.g. formed to determine at least one property Iₘ of the measurement radiation LM, such as e.g. an intensity, spectral intensity values or an intensity spectrum of the measurement radiation LM in a measurement spectral region, in which the measurement radiation LM resulting from the wavelength-changing interaction of the transmission radiation L0 with the medium 1 occurs.

In such case, in sensors using wavelength-changing interactions, e.g. an optical system is applied, in whose transmission path P input side the lens 9 is applied, and which is formed to transmit transmission radiation L0 produced by means of the transmission system 3 into the medium 1 and to transmit the measurement radiation LM resulting from the wavelength-changing interaction to the measuring detector 5.

The sensor shown in FIG. 4 as an example includes an optical system described in the German patent application DE 102024137273.7 filed Dec. 11, 2024 and incorporated here by reference. Such optical system includes a filter 37, which is installed in a first signal path extending along a first optical axis and which divides the first signal path into a unidirectional transmission path P and a bidirectional transmitting-and receiving path serving for transmitting the transmission radiation L0 and for receiving radiation LR exiting from the medium 1. Filter 37 is formed as a bandpass-interference filter and is inclined relative to the first optical axis in such a manner that between a normal vector to the inclined filter 37 and the first optical axis an angle of inclination α different from zero degrees is formed. The angle of inclination α is selected in such a manner that the inclined filter 37 transmits as excitation radiation LE signal fractions of the transmission radiation L0 lying within its passband and supplied by means of the transmission system 3 into the transmission path P, and reflects impinging radiation signal fractions LR lying outside of its passband received via the bidirectional transmitting-and receiving path and provides such as measurement radiation LM. Optionally, the sensor shown in FIG. 4 is e.g. also formed in such a manner that the measuring detector 5 and the transmission system 3 are arranged on the support 13 also, in such case, comprising e.g. a circuit board. In the case of the sensor shown in FIG. 4, the optical system includes, for this, extending along a second optical axis extending in parallel with the first optical axis, a second signal path, where terminally a reflector 39 is installed, which is arranged and oriented relative to the inclined filter 37 in such a manner that the measurement radiation LM reflected from the inclined filter 37 impinges on the reflector 39 and is there reflected to the measuring detector 5.

Analogously to the sensors illustrated in FIGS. 1 to 3 based on wavelength-preserving interactions, also in the case of sensors based on a wavelength-changing interaction, such as e.g. in the case of the sensor shown in FIG. 4, at least one reference detector 11 is provided, which is arranged and formed in the same manner described above in connection with the sensors illustrated in FIGS. 1 to 3.

A form of embodiment of sensors based on a wavelength-changing interaction, such as e.g. the sensor shown in FIG. 4, provides that the reference detector 11 is formed to determine as reference property I_{ref} an intensity of the thereon impinging part of the radiation fraction R of the transmission radiation L0 reflected on the lens 9. In the case of this form of embodiment, the measuring electronics 7 is e.g. formed to determine and provide measured values of the measured variable of the medium 1 based on ratios of intensities or spectral intensity values of the measurement radiation LM determined with the measuring detector 5 in the measuring spectral region to the reference property I_{ref} determined by the reference detector 11. Such offers the advantage that changes of the intensity of the transmission radiation L0, which lead to corresponding changes of the intensity or the spectral intensities of the measurement radiation LM are automatically taken into consideration and correspondingly compensated when determining the measured values.

Alternatively or supplementally to the above described embodiments, the medium 1 can be provided in different ways. A form of embodiment shown in FIG. 1 provides that the medium 1 is arranged in a flow-through cell 41. FIG. 2 shows an alternative example of an embodiment, in the case of which the sensor is formed as an immersion probe, which comprises a recess 43 open to the environment, such as e.g. a measurement slit, which fills with the medium 1 upon immersion of the immersion probe in the medium 1. FIG. 3 shows an embodiment, in the case of which the medium 1 is located in a cuvette 45.

In the case of these examples of embodiments, e.g. correspondingly positioned windows 46 or transparent regions are provided, through which the transmission radiation L0 is transmitted into the medium 1 and the measurement radiation LM emerging from the medium 1 received. FIG. 4 shows an example of an embodiment, in the case of which the sensor includes a process interface 47, such as e.g. a window, through which the transmission radiation L0 enters into the medium 1 bordering outside at process interface 47 and the radiation LR emerging from the medium 1 and comprising the measurement radiation LM is received.

Optionally, the optical systems of the here described sensors can, supplementally to the lens 9, include other optical components, such as e.g. lenses, apertures, filters, and/or reflectors. FIGS. 1 to 4 show as an example a focusing system 49, such as e.g. a focusing lens, which focuses the measurement radiation LM on the measuring detector 5. FIG. 4 shows, as other examples, an optical means 51, such as e.g. an objective lens, which is formed to focus excitation radiation LE transmitted by the optical system onto a region lying outside of the optical means, such as e.g. a focal point, a focal line or a bounded area, and starting from the region to collimate radiation LR entering into the bidirectional transmitting-and receiving path, and a band limiting filter 53, which limits a wavelength range of the measurement radiation LM transmitted to the measuring detector 5 to a measuring wavelength range predetermined as a function of the measured variable.

The present disclosure is not limited to the sensors described here, but, instead, is usable analogously in sensors having other optical systems and/or other constructions, such as e.g. sensors working according to the principle of fluorescence quenching, oxygen sensors working according to the principle of fluorescence quenching, or ATR sensors working according to the principle of attenuated total reflection, whose optical system can be equipped with a lens applied input side in the transmission path P.

Claimed is:

1. A sensor for measuring at least one measured variable of a medium, comprising:
a transmission system, configured to transmit electromagnetic transmission radiation along a transmission path into the medium;
a lens arranged on an input side in the transmission path;
a measuring detector, configured to receive measurement radiation resulting from an interaction of the transmission radiation with the medium and to determine and provide at least one property of the measurement radiation dependent on the at least one measured variable; and
at least one reference detector arranged such that a part of a radiation fraction of the transmission radiation reflected on the lens impinges thereon, and configured to determine and provide at least one reference property of the thereon impinging part of the radiation fraction of the transmission radiation reflected on the lens.

2. The sensor as claimed in claim 1, wherein:
the sensor is embodied as a turbidity sensor, as a sensor for measuring a solids concentration contained in the medium, as a fluorescence sensor, as an absorption sensor, as a sensor operating on fluorescence quenching, as an oxygen sensor operating on fluorescence quenching or as a sensor operating on attenuated total reflection;
the transmission system includes at least one light source, at least one light emitting diode, an incandescent light bulb, a flash lamp, a gas discharge lamp, a xenon lamp, at least one laser diode or a laser, wherein
the transmission system is configured to transmit transmission radiation in a spectral region having at least one transmission wavelength and/or at least one transmission wavelength range, and
the transmission system includes either a light source, configured to transmit light in a spectral region of the transmission system, or two or more light sources operable simultaneously and/or in a time sequence determined by a control unit and configured to transmit light in different subranges of the spectral region of the transmission system;
the measuring detector includes at least one detection system, at least one photodiode, a detector array, a photodiodes array or a spectrometer, and/or is configured to determine, as at least one property of the measurement radiation dependent on the measured variable, an intensity, at least one spectral intensity value or an intensity spectrum of the measurement radiation; and
each reference detector comprises at least one detection system, at least one photodiode, a detector array, a photodiodes array or a spectrometer, and/or is configured to determine, as at least one reference property, an intensity, at least one spectral intensity value and/or an intensity spectrum of the thereon impinging part of the radiation fraction of the transmission radiation reflected on the lens, and/or
the reference detector, at least one of the reference detectors or each reference detector includes a detection system or a detection system embodied as a photodiode and a filter placed in front of the detection system, wherein the filter is formed as a bandpass filter, as an edge filter, or as a notch filter and/or as a filter transparent in a wavelength range predetermined for the reference detector.

3. The sensor as claimed in claim 1, further comprising a support or a support comprising a circuit board, wherein the transmission system and each reference detector are arranged on a side of the support facing the lens.

4. The sensor as claimed in claim 3, wherein the measuring detector is arranged on the support and/or the sensor includes an optical system configured to transmit measurement radiation resulting from the interaction with the medium to the measuring detector arranged on the support.

5. The sensor as claimed in claim 1, wherein:
the lens is embodied such that the radiation fraction reflected on the lens propagates as a divergent beam formed rotationally symmetrically to a symmetry axis predetermined by an orientation of an optical axis of the lens extending coaxially with the transmission path; and
two or more reference detectors are arranged in a plane extending spaced from the lens and perpendicularly to the symmetry axis and are distributed around the symmetry axis such that they are located at equal separations from the symmetry axis.

6. The sensor as claimed in claim 1, further comprising two or more reference detectors, wherein
the two or more reference detectors are arranged in a plane;
the two or more reference detectors are arranged distributed around the transmission system; and/or
the transmission system and the two or more reference detectors are arranged on a side of a support facing the lens such that the two or more reference detectors are arranged distributed around the transmission system in a circular ring-shaped region of the support.

7. The sensor as claimed in claim 6, wherein the two or more reference detectors comprise, for two or more subranges of a spectral region of the transmission system, for each subrange, a reference detector configured to determine, as a reference property, an intensity of the thereon impinging part of the reflected radiation fraction in a respective subrange.

8. The sensor as claimed in claim 7, further comprising a measuring electronics connected to the measuring detector and to each reference detector, wherein:
the measurement radiation results from a wavelength-preserving interaction; and
the measuring electronics is configured to determine and provide measured values of the measured variable of the medium based on ratios of intensities or spectral intensity values of the measurement radiation determined as properties in the individual subranges of the measuring detector to the intensity determined in each subrange as reference property by the reference detector provided for each subrange.

9. The sensor as claimed in claim 1, further comprising a control device connected to the transmission system and configured to control a transmission intensity of the transmission radiation transmitted by the transmission system to a predetermined desired intensity based on at least one reference property determined by one or more reference detectors connected to the control device.

10. The sensor as claimed in claim 1, further comprising a monitoring system connected to the reference detector or to at least one or each reference detector and configured to monitor the transmission radiation transmitted by the transmission system based on at least one or each reference property determined by one or more reference detectors connected to the monitoring system and/or to output an alarm when a reference property and/or a characteristic variable determined by the monitoring system based on the reference property(ies) is outside of a range desired therefor.

11. The sensor as claimed in claim 10, wherein the monitoring system is configured to monitor a spectral composition of the transmission radiation transmitted by the transmission system based on reference properties determined with two or more reference detectors connected thereto in at least two different subranges of the spectral region of the transmission system and/or to output an alarm when at least one characteristic variable of the spectral composition determined by the monitoring system based on the reference properties is outside of a desired range predetermined therefor.

12. The sensor as claimed in claim 10, wherein
the reference detectors comprise, for at least two subranges of the spectral region of the transmission system, for the case of each subrange, a reference detector, which determines as a reference property an intensity of the thereon impinging part of the reflected radiation fraction in the respective subrange; and
the monitoring system is configured to monitor the spectral composition of the transmission radiation based on one or more ratios of two reference properties determined in different subranges, and/or to output an alarm when at least one of the ratios lies outside of a desired range predetermined therefor.

13. The sensor as claimed in claim 1, further comprising a measuring electronics, wherein the measuring electronics:
is connected to the measuring detector and to the reference detector or to at least one or each reference detector; and
is configured to determine and provide measurement results of the measured variable based on properties of the measurement radiation determined by the measuring detector and dependent on the measured variable and based on reference properties determined by at least one reference detector.

14. The sensor as claimed in claim 13, wherein the measuring electronics is configured to determine the results of measurement as a measurement result compensated with respect to a dependence of the properties of the measurement radiation dependent on the measured variable on at least one property of the transmission radiation metrologically registered based on the reference property(ies).

15. The sensor as claimed in claim 13, wherein
the reference detector is configured to determine as a reference property an intensity of the thereon impinging part of the radiation fraction of the transmission radiation reflected on the lens; and
the measuring electronics is configured to determine and provide measured values of the measured variable of the medium based on ratios of intensities or spectral intensity values of the measurement radiation determined with the measuring detector as properties to the intensities determined as reference properties by the reference detector.

16. The sensor as claimed in claim 13, wherein
the measurement radiation results from a wavelength-preserving interaction;
the reference detector is configured to determine spectral intensity values of the thereon impinging part of the radiation fraction of the transmission radiation reflected on the lens as a reference property;
the measuring detector is configured to determine as properties spectral intensity values of the measurement radiation; and
the measuring electronics is configured to determine and provide measured values of the measured variable based on ratios of the spectral intensity values determined by the measuring detector and the reference detector for the same wavelength.
